(19) United States
(12) Patent Application Publication
(10) Pub. No.: US 2009/0112932 A1
(43) Pub. Date: Apr. 30, 2009

(54) VISUALIZING KEY PERFORMANCE INDICATORS FOR MODEL-BASED APPLICATIONS

(75) Inventors: Maciej Skierkowski, Seattle, WA (US); Vladimir Pogrebinsky, Sammamish, WA (US); Gilles C. J.A. Zunino, Kirkland, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/105,083

(22) Filed: Apr. 17, 2008

Related U.S. Application Data
(60) Provisional application No. 60/983,117, filed on Oct. 26, 2007.

(51) Int. Cl. G06F 17/30

(52) U.S. Cl. 707/104.1; 707/E17.001

(57) ABSTRACT

The present invention extends to methods, systems, and computer program products for visualizing key performance indicators for model-based applications. A composite application model defines how to graphically present an interactive user surface for a composite application from values of a key performance indicator for the composite application. A presentation module accesses values of the key performance indicator for a specified time span. The presentation module graphically presents an interactive user surface for the values of the key performance indicator for the specified time span in accordance with the definitions in the composite application model. Interface controls are provided to manipulate how the data is presented, such as, for example, panning and zooming on key performance indication values. Other relevant data can also be presented along with key performance indicator values to assist a user in understanding the meaning of key performance indication values.

### CROSS-REFERENCE TO RELATED APPLICATIONS

This application claims the benefit of U.S. Provisional Patent Application No. 60/983,117, entitled “Visualizing Key Performance Indicators For Model-Based Applications”, filed on Nov. 7, 2007, which is incorporated herein in its entirety.

### BACKGROUND

1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing components.

As computerized systems have increased in popularity, so have the complexity of the software and hardware employed within such systems. In general, the need for seemingly more complex software continues to grow, which further tends to be one of the forces that push greater development of hardware. For example, if application programs require too much of a given hardware system, the hardware system can operate inefficiently, or otherwise be unable to process the application program at all. Recent trends in application program development, however, have removed many of these types of hardware constraints at least in part using distributed application programs.

In general, distributed application programs comprise components that are executed over several different hardware components. Distributed application programs are often large, complex, and diverse in their implementations. Further, distributed applications can be multi-tiered and have many (differently configured) distributed components and subsystems, some of which are long-running workflows and legacy or external systems (e.g., SAP). One can appreciate, that while this ability to combine processing power through several different computer systems can be an advantage, there are various complexities associated with distributing application program modules.

For example, the very distributed nature of business applications and variety of their implementations creates a challenge to consistently and efficiently monitor and manage such applications. The challenge is due at least in part to diversity of implementation technologies composed into a distributed application program. That is, diverse parts of a distributed application program have to behave coherently and reliably. Typically, different parts of a distributed application program are individually and manually made to work together. For example, a user or system administrator creates text documents that describe how and when to deploy and activate parts of an application and what to do when failures occur. Accordingly, it is then commonly a manual task to act on the application lifecycle described in these text documents.

Further, changes in demands can cause various distributed application modules to operate at a sub-optimum level for significant periods of time before the sub-optimum performance is detected. In some cases, an administrator (depending on skill and experience) may not even attempt corrective action, since improperly implemented corrective action can cause further operational problems. Thus, a distributed application module could potentially become stuck in a pattern of inefficient operation, such as continually rebooting itself, without ever getting corrected during the lifetime of the distributed application program.

Various techniques for automated monitoring of distributed applications have been used to reduce, at least to some extent, the level of human interaction that is required to fix undesirable distributed application behaviors. However, these monitoring techniques suffer from a variety of inefficiencies.

For example, to monitor a distributed application, the distributed application typically has to be instrumented to produce events. During execution the distributed application produces the events that are sent to a monitor module. The monitor module then uses the events to diagnose and potentially correct undesirable distributed application behavior. Unfortunately, since the instrumentation code is essentially built into the distributed application there is little, if any, mechanism that can be used to regulate the type, frequency, and contents of produced events. As such, producing monitoring events is typically an all or none operation.

As a result of the inability to regulate produced monitoring events, there is typically no way during execution of distributed application to adjust produced monitoring events (e.g., event types, frequencies, and content) for a particular purpose. Thus, it can be difficult to dynamically configure a distributed application to produce monitoring events in a manner that assists in monitoring and correcting a specific undesirable application behavior. Further, the monitoring system itself, through the unregulated production of monitoring events, can aggravate or compound existing distributed application problems. For example, the production of monitoring events can consume significant resources at worker machines and can place more messages on connections that are already operating near capacity.

Additionally, when source code for a distributed application is compiled (or otherwise converted to machine-readable code), a majority of the operating intent of the distributed application is lost. Thus, a monitoring module has limited, if any, knowledge, of the intended operating behavior of a distributed application when it monitors the distributed application. Accordingly, during distributed application execution, it is often difficult for a monitoring module to determine if undesirable behavior is in fact occurring.

The monitoring module can attempt to infer intent from received monitoring events. However, this provides the monitoring module with limited and often incomplete knowledge of the intended application behavior. For example, it may be that an application is producing seven messages a second but that the intended behavior is to produce only five messages a second. However, based on information from received monitoring events, it can be difficult, if not impossible, for a monitor module to determine that the production of seven messages a second is not intended.

Further, even when relevant events are appropriately collected and stored, there are limited, if any, mechanisms to visually represent such events in a meaningful, interactive manner, that is useful to a system administrator or other user.

### BRIEF SUMMARY

The present invention extends to methods, systems, and computer program products for visualizing key performance indicators for model-based applications. Generally, a composite application model defines a composite application and can also define any of a number of other different types of data and/or instructions. The composite application model can include other models, such as, for example, an observation model. The observation model defines how to process event data generated by the composite application and how to measure a key performance indication for the composite application. The composite application model can also define instructions that an event infrastructure is to consumer. The instructions can define what event data is to be collected from an event store for the composite application, where to store collected event data for the composite application, and how to calculate a health state for a key performance indication from the stored event data.

Monitoring services collect event data for the composite application from the event store in accordance with the observation model over a specified period of time. The collected event data is stored in accordance with the define instructions in the observation model. A health state is calculated for the key performance indicator access the specified period of time. The health state is calculated based on stored event data in accordance with the defined instructions in the observation model.

Embodiments also include presenting values for a key performance indicator. A composite application model can also define how to graphically present an interactive user surface for a composite application from values of a key performance indicator for the composite application. A presentation module accesses values of a key performance indicator for the composite application for a specified time span. The presentation module graphically presents an interactive user surface for the values of the key performance indicator for the specified time span in accordance with the definitions in the composite application model.

The interactive user surface includes a key performance indicator graph indicating the value of the key performance indicator over time. The key performance indicator graph includes a plurality of selectable information points, each selectable information point providing relevant information for the application at particular time within the specified time span. The interactive user surface also includes one or more key performance indicator health transitions indicating when the value of the key performance indicator transitioned between thresholds representing different health states for the composite application.

The interactive user surface also includes interface controls configured to respond to user input to manipulate the configuration of the key performance indicator graph. The interface controls can be used to perform one or more of: changing the size of a sub-span within the specified time span to correspondingly change how much of the specified time span is graphically represented in the key performance indicator graph and dragging a sub-span within the specified time span to pan through specified time span.

In further embodiments, other relevant data is presented along with a key performance indicator graph. In these further embodiments, a composite application model defines a composite application, how to access values for at least on key performance indication for the composite application, and how to access other relevant data for the composite application. The other relevant data for assisting the user in interpreting the meaning of the at least one key performance indicator.

The presentation module accesses values for a key performance indicator for a specified time span and in accordance with the composite application model. The presentation module accesses other relevant data in accordance with the composite application model. The presentation module refers to a separate presentation model that defines how to visually co-present the other relevant data along with values for the key performance indication.

The presentation module presents a user surface for the composite application. The user surface includes a key performance indicator raph. The key performance indicator graph indicates the value of the key performance indicator over the specified time span. The user surface also includes the other relevant data. The other relevant data assists in interpreting the meaning of the key performance indicator graph. The other relevant data is co-presented along with the key performance indicator graph in accordance with definitions in the separate presentation module.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computer architecture that facilitates maintaining software lifecycle.

FIG. 1B illustrates an expanded view of some of the components from the computer architecture of FIG. 1A.

FIG. 1C illustrates an expanded view of other components from the computer architecture of FIG. 1A.

FIG. 1D illustrates a presentation module for presenting heath state information for a composite application running in the computer architecture of FIG. 1A.

FIGS. 2A and 2B illustrates example visualizations of a user surface 200 that includes values for a key performance indicator.

FIG. 3 illustrates a flow chart of an example method for calculating a key performance indicator value for an application.

FIG. 4 illustrates a flow chart of an example method for interactively visualizing a key performance indicator value over a span of time.

FIG. 5 illustrates a flow chart of an example method for correlating a key performance indicator visualization with other relevant data for an application.

### DETAILED DESCRIPTION

The present invention extends to methods, systems, and computer program products for for visualizing key performance indicators for model-based applications. Generally, a composite application model defines a composite application and can also define any of a number of other different types of data and/or instructions. The composite application model can include other models, such as, for example, an observation model. The observation model defines how to process event data generated by the composite application and how to measure a key performance indication for the composite application. The composite application model can also define instructions that an event infrastructure is to consumer. The instructions can define what event data is to be collected from an event store for the composite application, where to store collected event data for the composite application, and how to calculate a health state for a key performance indication from the stored event data.

Monitoring services collect event data for the composite application from the event store in accordance with the observation model over a specified period of time. The collected event data is stored in accordance with the define instructions in the observation model. A health state is calculated for the key performance indicator access the specified period of time. The health state is calculated based on stored event data in accordance with the defined instructions in the observation model.

Embodiments also include presenting values for a key performance indicator. A composite application model can also define how to graphically present an interactive user surface for a composite application from values of a key performance indicator for the composite application. A presentation module accesses values of a key performance indicator for the composite application for a specified time span. The presentation module graphically presents an interactive user surface for the values of the key performance indicator for the specified time span in accordance with the definitions in the composite application model.

The interactive user surface includes a key performance indicator graph indicating the value of the key performance indicator over time. The key performance indicator graph includes a plurality of selectable information points, each selectable information point providing relevant information for the application at particular time within the specified time span. The interactive user surface also includes one or more key performance indicator health transitions indicating when the value of the key performance indicator transitioned between thresholds representing different health states for the composite application.

The interactive user surface also includes interface controls configured to respond to user input to manipulate the configuration of the key performance indicator graph. The interface controls can be used to perform one or more of: changing the size of a sub-span within the specified time span to correspondingly change how much of the specified time span is graphically represented in the key performance indicator graph and dragging a sub-span within the specified time span to pan through specified time span.

In further embodiments, other relevant data is presented along with a key performance indicator graph. In these further embodiments, a composite application model defines a composite application, how to access values for at least on key performance indication for the composite application, and how to access other relevant data for the composite application. The other relevant data for assisting the user in interpreting the meaning of the at least one key performance indicator.

The presentation module accesses values for a key performance indicator for a specified time span and in accordance with the composite application model. The presentation module accesses other relevant data in accordance with the composite application model. The presentation module refers to a separate presentation model that defines how to visually co-present the other relevant data along with values for the key performance indication.

The presentation module presents a user surface for the composite application. The user surface includes a key performance indicator raph. The key performance indicator graph indicates the value of the key performance indicator over the specified time span. The user surface also includes the other relevant data. The other relevant data assists in interpreting the meaning of the key performance indicator graph. The other relevant data is co-presented along with the key performance indicator graph in accordance with definitions in the separate presentation module.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, it should be understood, that upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

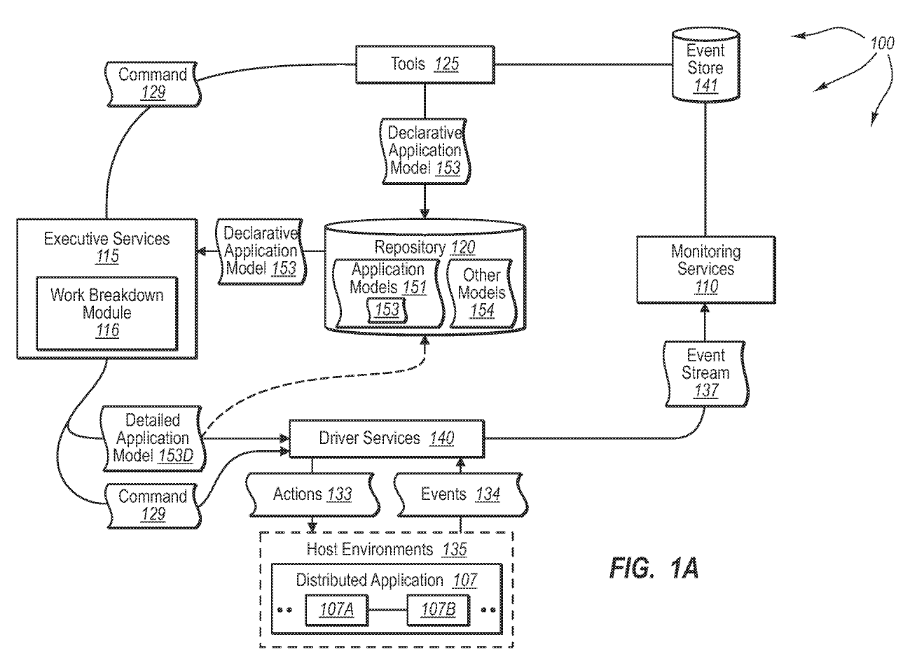

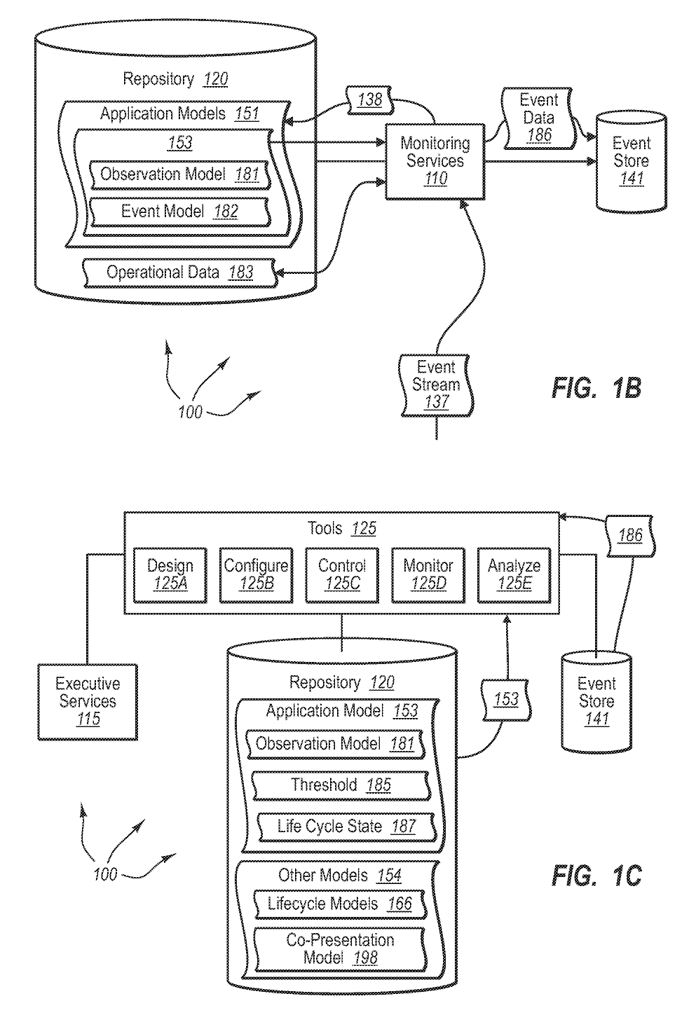

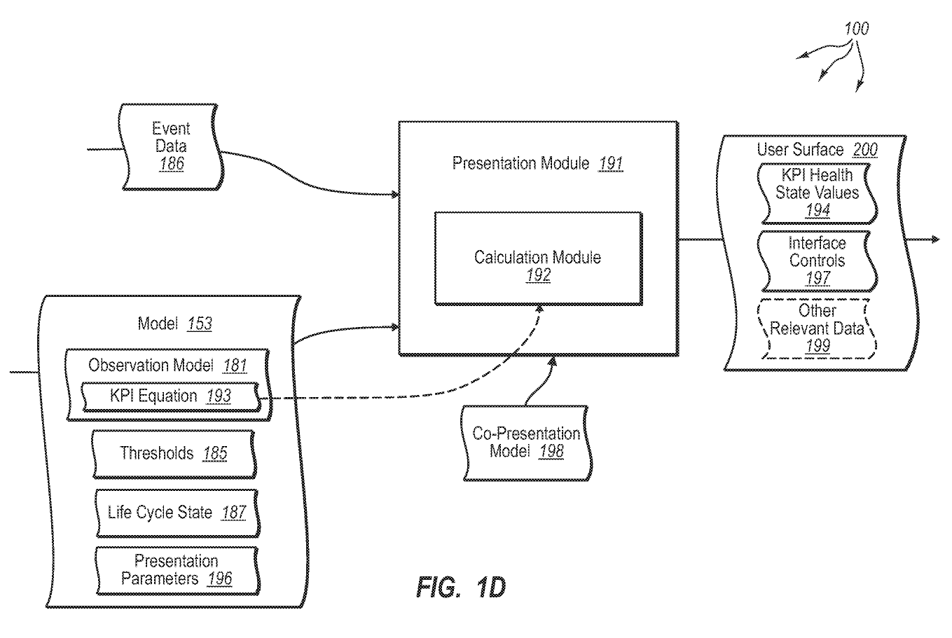

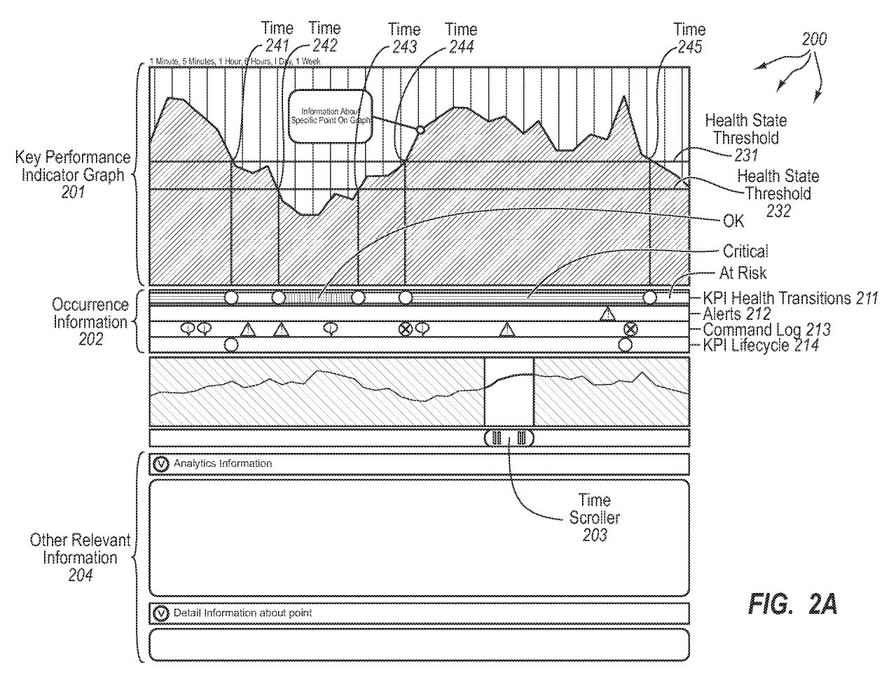

FIG. 1A illustrates an example computer architecture 100 that facilitates maintaining software lifecycle. Referring to FIG. 1A, computer architecture 100 includes tools 125, repository 120, executive services 115, driver services 140, host environments 135, monitoring services 110, and events store 141. Each of the depicted components can be connected to one another over (or be part of) a network, such as, for example, a Local Area Network (“LAN”), a Wide Area Network (“WAN”), and even the Internet. Accordingly, each of the depicted components as well as any other connected components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

As depicted, tools 125 can be used to write and modify declarative models for applications and store declarative models, such as, for example, declarative application models 151 (including declarative application model 153) and other models 154, in repository 120. Declarative models can be used to describe the structure and behavior of real-world running (deployable) applications and to describe the structure and behavior of other activities related to applications. Thus, a user (e.g., distributed application program developer) can use one or more of tools 125 to create declarative application model 153. A user can also use one or more of tools 123 to create some other model for presenting data related to an application based declarative application model 153 (and that can be included in other models 154).

Generally, declarative models include one or more sets of high-level declarations expressing application intent for a distributed application. Thus, the high-level declarations generally describe operations and/or behaviors of one or more modules in the distributed application program. However, the high-level declarations do not necessarily describe implementation steps required to deploy a distributed application having the particular operations/behaviors (although they can if appropriate). For example, declarative application model 153 can express the generalized intent of a workflow, including, for example, that a first Web service be connected to a database. However, declarative application model 153 does not necessarily describe how (e.g., protocol) nor where (e.g., address) the Web service and database are to be connected to one another. In fact, how and where is determined based on which computer systems the database and the Web service are deployed.

To implement a command for an application based on a declarative model, the declarative model can be sent to executive services 115. Executive services 115 can refine the declarative model until there are no ambiguities and the details are sufficient for drivers to consume. Thus, executive services 115 can receive and refine declarative application model 153 so that declarative application model 153 can be translated by driver services 140 (e.g., by one or more technology-specific drivers) into a deployable application.

Tools 125 can send command 129 to executive services 115 to perform a command for a model based application. Executive services 115 can report a result back to tools 125 to indicate the results and/or progress of command 129.

Accordingly, command 129 can be used to request performance of software lifecycle commands, such as, for example, create, verify, re-verify, clean, deploy, undeploy, check, fix, update, monitor, start, stop, etc., on an application model by passing a reference to the application model. Performance of lifecycle commands can result in corresponding operations including creating, verifying, re-verifying, cleaning, deploying, undeploying, checking, fixing, updating, monitoring, starting and stopping distributed model-based applications respectively.

In general, “refining” a declarative model can include some type of work breakdown structure, such as, for example, progressive elaboration, so that the declarative model instructions are sufficiently complete for translation by drivers 142. Since declarative models can be written relatively loosely by a human user (i.e., containing generalized intent instructions or requests), there may be different degrees or extents to which executive services 115 modifies or supplements a declarative model for a deployable application. Work breakdown module 116 can implement a work breakdown structure algorithm, such as, for example, a progressive elaboration algorithm, to determine when an appropriate granularity has been reached and instructions are sufficient for driver services 140.

Executive services 115 can also account for dependencies and constraints included in a declarative model. For example, executive services 115 can be configured to refine declarative application model 153 based on semantics of dependencies between elements in the declarative application model 153 (e.g., one web service connected to another). Thus, executive services 115 and work breakdown module 116 can interoperate to output detailed declarative application model 153D that provides driver services 140 with sufficient information to realize distributed application 107.

In additional or alternative implementations, executive services 115 can also be configured to refine the declarative application model 153 based on some other contextual awareness. For example, executive services 115 can refine declarative application model based on information about the inventory of host environments 135 that may be available in the datacenter where distributed application 107 is to be deployed. Executive services 115 can reflect contextual awareness information in detailed declarative application model 153D.

In addition, executive services 115 can be configured to fill in missing data regarding computer system assignments. For example, executive services 115 can identify a number of different distributed application program modules in declarative application model 153 that have no requirement for specific computer system addresses or operating requirements. Thus, executive services 115 can assign distributed application program modules to an available host environment on a computer system. Executive services 115 can reason about the best way to fill in data in a refined declarative application model 153. For example, as previously described, executive services 115 may determine and decide which transport to use for an endpoint based on proximity of connection, or determine and decide how to allocate distributed application program modules based on factors appropriate for handling expected spikes in demand. Executive services 115 can then record missing data in detailed declarative application model 153D (or segment thereof).

In addition or alternative implementations, executive services 115 can be configured to compute dependent data in the declarative application model 153. For example, executive services 115 can compute dependent data based on an assignment of distributed application program modules to host environments on computer systems. Thus, executive services 115 can calculate URI addresses on the endpoints, and propagate the corresponding URI addresses from provider endpoints to consumer endpoints. In addition, executive services 115 may evaluate constraints in the declarative application model 153. For example, the executive services 115 can be configured to check to see if two distributed application program modules can actually be assigned to the same machine, and if not, executive services 115 can refine detailed declarative application model 153D to accommodate this requirement.

Accordingly, after adding appropriate data (or otherwise modifying/refining) to declarative application model 153 (to create detailed declarative application model 153D), executive services 115 can finalize the refined detailed declarative application model 153D so that it can be translated by platform-specific drivers included in driver services 140. To finalize or complete the detailed declarative application model 153D, executive services 115 can, for example, partition a declarative application model into segments that can be targeted by any one or more platform-specific drivers. Thus, executive services 115 can tag each declarative application model (or segment thereof) with its target driver (e.g., the address or the ID of a platform-specific driver).

Furthermore, executive services 115 can verify that a detailed application model (e.g., 153D) can actually be translated by one or more platform-specific drivers, and, if so, pass the detailed application model (or segment thereof) to a particular platform-specific driver for translation. For example, executive services 115 can be configured to tag portions of detailed declarative application model 153D with labels indicating an intended implementation for portions of detailed declarative application model 153D. An intended implementation can indicate a framework and/or a host, such as, for example, WCF-IIS, Active Service Pages .NETAspx-IIS, SQL, Axis-Tomcat, WF/WCF-WAS, etc.

After refining a model, executive services 115 can forward the model to driver services 140 or store the refined model back in repository 120 for later use. Thus, executive services 115 can forward detailed declarative application model 1 53D to driver services 140 or store detailed declarative application model 153D in repository 120. When detailed declarative application model 153D is stored in repository 120, it can be subsequently provided to driver services 140 without further refinements.

Executive service 115 can send command 129 and a reference to detailed declarative application model 153D to driver services 140. Driver services 140 can then request detailed declarative application model 153D and other resources from executive services 115 to implement command 129. Driver services 140 can then take actions (e.g., actions 133) to implement an operation for a distributed application based on detailed declarative application model 153D. Driver services 140 interoperate with one or more (e.g., platform-specific) drivers to translate detailed application module 153D (or declarative application model 153) into one or more (e.g., platform-specific) actions 133. Actions 133 can be used to realize an operation for a model-based application.

Thus, distributed application 107 can be implemented in host environments 135. Each application part, for example, 107A, 107B, etc., can be implemented in a separate host environment and connected to other application parts via correspondingly configured endpoints.

Accordingly, the generalized intent of declarative application model 135, as refined by executive services 115 and implemented by drivers accessible to driver services 140, is expressed in one or more of host environments 135. For example, when the general intent of declarative application model is to connect two Web services, specifics of connecting the first and second Web services can vary depending on the platform and/or operating environment. When deployed within the same data center Web service endpoints can be configured to connect using TCP. On the other hand, when the first and second Web services are on opposite sides of a firewall, the Web service endpoints can be configured to connect using a relay connection.

To implement a model-based command, tools 125 can send a command (e.g., command 129) to executive services 115. Generally, a command represents an operation (e.g., a lifecycle state transition) to be performed on a model. Operations include creating, verifying, re-verifying, cleaning, deploying, undeploying, checking, fixing, updating, monitoring, starting and stopping distributed applications based on corresponding declarative models.

In response to the command (e.g., command 129), executive services 115 can access an appropriate model (e.g., declarative application model 153). Executive services 115 can then submit the command (e.g., command 129) and a refined version of the appropriate model (e.g., detailed declarative application model 153D) to driver services 140. Driver services 140 can use appropriate drivers to implement a represented operation through actions (e.g., actions 133). Results of implementing the operation can be returned to tools 125.

Distributed application programs can provide operational information about execution. For example, during execution distributed application can emit events 134 indicative of events (e.g., execution or performance issues) that have occurred at a distributed application.

Driver services 140 collect emitted events and send out event stream 137 to monitoring services 110 on a continuous, ongoing basis, while, in other implementations, event stream 137 is sent out on a scheduled basis (e.g., based on a schedule setup by a corresponding platform-specific driver).

Generally, monitoring services 110 can perform analysis, tuning, and/or other appropriate model modification. As such, monitoring service 110 aggregates, correlates, and otherwise filters data from event stream 137 to identify interesting trends and behaviors of a distributed application. Monitoring service 110 can also automatically adjust the intent of declarative application model 153 as appropriate, based on identified trends. For example, monitoring service 110 can send model modifications to repository 120 to adjust the intent of declarative application model 153. An adjusted intent can reduce the number of messages processed per second at a computer system if the computer system is running low on system memory, redeploy a distributed application on another machine if the currently assigned machine is rebooting too frequently, etc. Monitoring service 110 can store any results in event store 141.

Accordingly, in some embodiments, executive services 115, drivers services 140, and monitoring services 110 interoperate to implement a software lifecycle management system. Executive services 115 implement command and control function of the software lifecycle management system applying software lifecycle models to application models. Driver services 140 translate declarative models into actions to configure and control model-based applications in corresponding host environments. Monitoring services 110 aggregate and correlate events that can used to reason on the lifecycle of model-based applications.

FIG. 1B illustrates an expanded view of some of the contents of repository 120 in relation to monitoring services 110 from FIG. 1A. Generally, monitoring service 110 process events, such as, for example, event stream 137, received from driver services 140. As depicted, declarative application model 153 includes observation model 181 and event model 182. Generally, event models define events that are enabled for production by driver services 140. For example, event model 182 defines particular events enabled for production by driver services 140 when translating declarative application model 153. Generally, observation models refer to event models for events used to compute an observation, such as, for example, a key performance indicator. For example, observation model 182 can refer to event model 181 for event types used to compute an observation of declarative application model 153.

Observation models can also combine events from a plurality of event models. For example in order to calculate average latency of completing purchase orders, “order received” and “order completed” events may be needed. Observation models can also refer to event stores (e.g., event store 141) to deposit results of computed observations. For example an observation model may describe that the average latency of purchase orders should be saved every one hour.

When a monitoring service 110 receives an event, it uses the event model reference included in the received event to locate observation models defined to use this event. The located observation models determine how event data is computed and deposited into event store 141.

FIG. 1C illustrates an expanded view of some of the components of tools 125 in relation to executive services 115, repository 120, and event store 141 from FIG. 1A. As depicted tools 125 includes a plurality of tools, including design 125A, configure 125B, control 125C, monitor 125D, and analyze 125E. Each of the tools is also model driven. Thus, tools 125 visualize model data and behave according to model descriptions.

Tools 125 facilitate software lifecycle management by permitting users to design applications and describe them in models. For example, design 125A can read, visualize, and write model data in repository 120, such as, for example, in application model 153 or other models 154, including life cycle model 166 or co-presentation model 198. Tools 125 can also configure applications by adding properties to models and allocating application parts to hosts. For example, configure tool 125B can add properties to models in repository 120. Tools 125 can also deploy, start, stop applications. For example, control tool 125C can deploy, start, and stop applications based on models in repository 120.

Tools 125 can monitor applications by reporting on health and behavior of application parts and their hosts. For example, monitor tool 125D can monitor applications running in host environments 135, such as, for example, distributed application 107. Tools 125 can also analyze running applications by studying history of health, performance and behavior and projecting trends. For example, analyze tool 125E can analyze applications running in host environments 135, such as, for example, distributed application 107. Tools 125 can also, depending on monitoring and analytical indications, optimize applications by transitioning application to any of the lifecycle states or by changing declarative application models in the repository.

Similar to other components, tools 125 use models stored in repository 120 to correlate user experiences and enable transitions across many phases of software lifecycle. Thus, tools 125 can also use software lifecycle models (e.g., 166) in order to determine phase for which user experience should be provided and to display commands available to act on a given model in its current software lifecycle state. As previously described, tools 125 can also send commands to executive services 115. Tools 125 can use observation models (e.g., 181) embedded in application models in order to locate Event Stores that contain information regarding runtime behavior of applications. Tools can also visualize information from event store 141 in the context of the corresponding application model (e.g. list key performance indicators computed based on events coming from a given application).

In some embodiments, tools 125 receive application model 153 and corresponding event data 186 and calculate a key performance indicator for distributed application 107.

In some embodiments, tools 125 receive application model 153 and corresponding event data 186 and calculate a key performance indicator for distributed application 107. For example, FIG. 1D illustrates a presentation module for presenting heath state information for a composite application running in the computer architecture of FIG. 1A. As depicted, presentation module 191 can receive event data 186 and model 153. Model 153 includes observation model 181 containing KPI equations 193, threshold 185, lifecycle state 187, and presentation parameters 196. Portions of presentation module 191 can be included in monitor 125D and analyze 125E as well as a visualization model or other tools 125.

From event data 186 and model 153, calculation module 192 can calculate KPI health state value 194. Calculation module 192 can receive KPI equation 193. Calculation module 192 can apply KPI equation 193 to event data 186 to calculate a KPI health state value 194 for a particular aspect of distributed application 107, such as, for example, “number of incoming purchase orders per minute”.

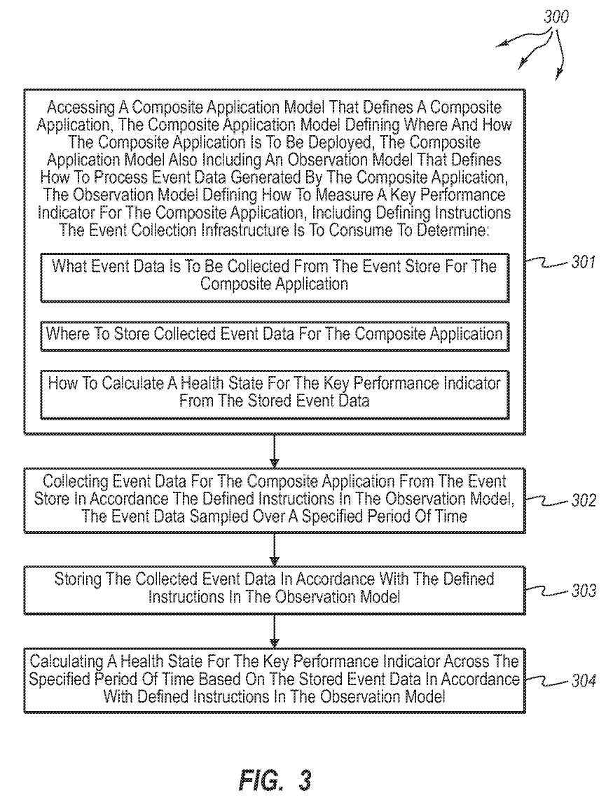

FIG. 3 illustrates a flow chart of a method 300 for calculating a key performance indicator value for an application. Method 300 will be described with respect to the components and data of computer architecture 100.

Method 300 includes an act of accessing a composite application model that defines a composite application (act 301). For example, in FIG. 1B monitoring services 110 can access declarative application model 153. The composite application model defines where and how the composite application is to be deployed. For example, referring for a moment back to FIG. 1A, declarative application model 153 can define how and where distributed application 107 is to be deployed

The composite application model also including an observation model that defines how to process event data generated by the composite application. For example, declarative application model 152 includes observation model 181 that defines how to process event data for distributed application 107. The observation model also defines how to measure a key performance indicator for the composite application. For example, referring now to FIG. 1D, observation model 153 includes KPI equation 191.

The observation model can also defines instructions the event collection infrastructure is to consume to determine: what event data is to be collected from the event store for the composite application, where to store collected event data for the composite application, how to calculate a health state for the key performance indicator from the stored event data. For example, observation model 181 can define what event data is to be collected from event store 141, where to store event data for processing, and how to calculate health state for the key performance indicator form calculated values for the key performance indicator.

Method 300 includes an act of collecting event data for the composite application from the event store in accordance the defined instructions in the observation model, the event data sampled over a specified period of time (act 302). For example, still referring to FIG. 1D, presentation module 191 can collect event data 186 from event store 141 in accordance with observation model 181. Event data 186 can be event data for distributed application 107 for a specified period of time.

Method 300 includes an act of storing the collected event data in accordance with the defined instructions in the observation model (act 303). For example, presentation module 191 can store event data 186 for use in subsequent calculations for values for one or more key performance indications of distributed application 107.

Method 300 includes an act of calculating a health state for the key performance indicator across the specified period of time based on the stored event data in accordance with defined instructions in the observation model (act 304). For example, utilizing KPI equation 193 and event data 186 calculation module 193 can calculate KPI health state values 194. KPI health state values 194 represent the values of a key performance indication over the span of time. Presentation module 191 can compare KPI health state values 194 to thresholds 185. Based on the comparisons, presentation module 191 can generate health state transitions (e.g., indicating if distributed application 107 is “good”, “at risk”, “critical”, etc.) for some the specified period of time (e.g., defined in presentation parameters 196).

Presentation module 191 can include KPI health state values 194 and health state transitions in a (potentially interactive) user surface. The user surface can also include interface controls allowing a user to adjust how data is presented through user surface.

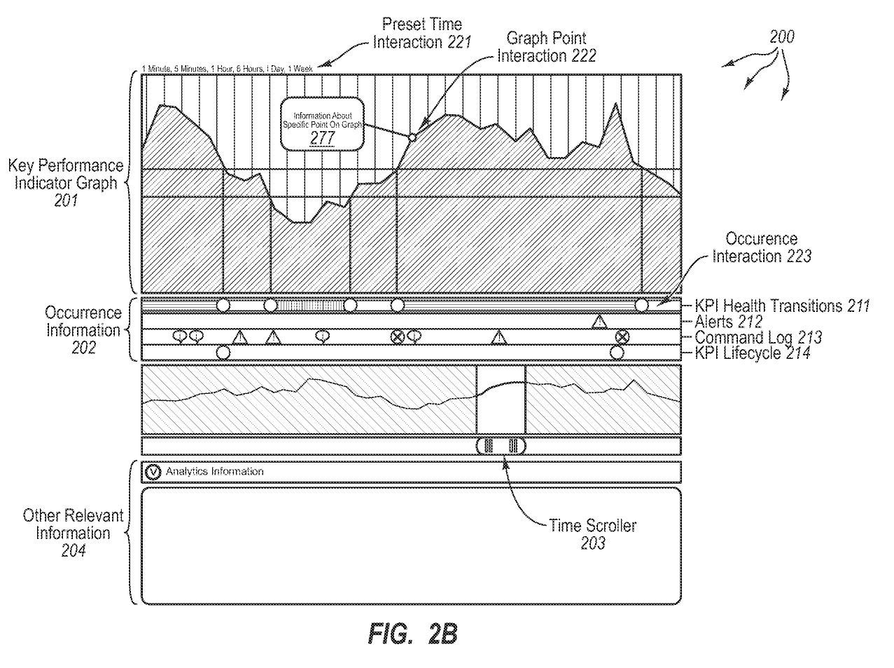

FIGS. 2A and 2B are examples of visualizations of a user surface 200 that includes values for a key performance indication. As depicted, user surface 200 includes KPI graph 201, occurrence information 202, time scroller 203, and other relevant information 204.

Generally, KPI Graph 201 visualizes a time based graph of the data on which the KPI calculations affect. For example, this could be a graph of the incoming rate of purchase orders. Occurrence Information 202 visualizes relevant event information. Occurrence information 202 includes KPI health state transitions 21 1, alerts 212, command log 213, and KPI lifecycle 214.

KPI health state transitions 211 indicate when an application (e.g., distributed application 107) transitions between states, such as, for example, “ok”, “at risk”, and “critical”. The no shading (e.g., the color yellow) represents “at risk”. The vertical shading (e.g., the color green) represents “ok”. The horizontal shading (e.g., the color red) represents “critical”.

Health state transitions can correspond to heath state value transitions between thresholds. For example, from the beginning of KPI graph 201 to time 241 the health state was “critical”. That is, the health state value was above health state threshold 231. Between time 241 and time 242 the health state was “at risk”. That is, the health state value was below health state threshold 231 and above health state threshold 232. Between time 242 and 243 the health state was “ok”. That is, the health state value was below health state threshold 232. Between time 244 and 244 the heath state is “at risk”. Between time 244 and time 245 the health state is “critical”. Between time 245 and the end of KPI graph 201 the health state is “ok”.

Both of health state thresholds 231 and 232 can be included in thresholds 185.

Time scroller 203 is an interface control permitting selection of a time span to observe. The scroll bar size can be increased to contain more information in the KPI Graph, and it can be panned. Doing this can correspondingly change the time span in the KPI graph 201

Other relevant information 204 visually represents relevant information at a sub-span of the total time of the life of the application. Other relevant information 204 shows relevant information for that time span, such as, for example, total time spent in the “at risk” state over the time window, details about KPI health transitions 211 at the specific selected time, etc. The ability to select the time span, instance and event instance, in addition to the combination of the model defining direct relevant information, the KPI definition itself, the event data, and calculable data facilitates a wide array of relevant data that can be bound to a KPI visualization.

As previously described, a composite application model (e.g., 153) defines the entire application; a subset of this model is the observation model (e.g., 181) which focuses on defining the model for collecting, storing, visualizing, computing and analyzing event data generated by the composite application and its components. A part of the observation model defines parameters that the event collection infrastructure reasons to understand, which event data to collect and where to store this data, and which event data is to be referred to as the event store. In addition to defining which data to collect and where to store the event data, this part of the observation model also reasons based on the parameters defined in the observation model how to aggregate this information in the event store.

Accordingly, various types of data can be used to generate user surface, such as, for example, key performance indicator event data, key performance indicator thresholds, and key performance indicator health states. Key performance indicator event data is the raw data that is collected and stored in a location accessible by the KPI visualization mechanisms (e.g., presentation module 191). This could be, for example, “number of incoming purchase orders per hour”. Key performance indicator thresholds define the boundaries between each health state. For example, for the number of incoming purchase orders per hour” there values could be <15, 15-20, and 20> corresponding to the three health states: healthy, at risk, and critical. Key performance indicator health states are the output of a KPI Calculation which is performed on the event data using the KPI Thresholds. With respect to the sample, the health states defined were “good”, “at risk” and “critical”.

Operating on these types of data, a KPI processor (e.g., calculation module 192) can access the thresholds (e.g., thresholds 185) and the event data (e.g., event data 186), and perform the threshold calculations resulting in an output (e.g., KPI health state values 194) that indicates the health state of the KPI.

Referring now to FIG. 2B, user surface 200 depicts various points of interaction with example visualizations 200. For example, preset time interface 221 can be used to value the time span duration. Clicking on any one of these time spans (1 minute, 5 minutes, 1 hour 6 hours, 1 day, 1 week, etc.) can adjust the selected time window to that duration. This can also update other relevant information 204.

Moving the mouse over any point of the graph selects the instant in time and inline with the graph will display tool-tip styled information for that moment in time. For example, selection of graph point interface 222 can cause information box 277 to appear. In occurrence information 202 there are a collection of indicators for events that occurred. Clicking on these items updates the information that is in other relevant information 204. Double clicking on an event can causes the time window to zoom by 200% and center at that instant in time. Time scroller 224 has the behavior of a scroll bar to move the time window for KPI Graph 201 across the complete life span of the data. The user can drag the window (i.e., pan) and change the size of the window (i.e., zoom) with the scroll bar.

Accordingly, a collection of visual cues enables a human to: (1) select a single moment in time using the graph point interactivity, (2) select a span of time using the present time interactivity or the time scroller, and (3) select a specific instance of an event that occurred during the visualized time span. The human interaction uses any type of human interaction the computing system supports; as an example on a standard PC this may be a mouse gesture or a keyboard input, while on a Tablet PC this can be the pen device.

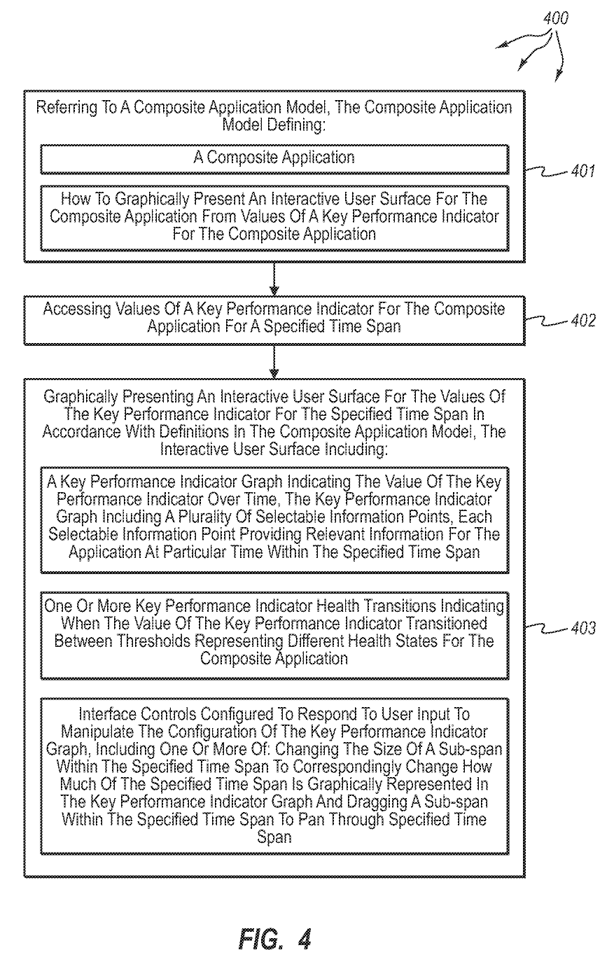

FIG. 4 illustrates a flow chart of an example method 400 for interactively visualizing a key performance indicator value over a span of time. Method 400 will be described with respect to the components and data of computer architecture 100 and with respect to user surface 200.

Method 400 includes an act of referring to a composite application model (act 401). For example, presentation module 191 can refer to declarative model 153. The composite application model defines a composite application and how to graphically present an interactive user surface for the composite application from values of a key performance indicator for the composite application. For example, model 153 can defines a composite application (e.g., distributed application 107) and how to present an interactive user surface for the composite application from event data 186.

Method 400 includes an act of accessing values of a key performance indicator for the composite application for a specified time span (act 402). For example, presentation module 191 can access KPI health state values 194 for distributed application 107 for a specified period of time. Presentation module 191 can include KPI health state values 194 along with interface controls 197 in user surface 195.

Method 400 includes an act of graphically presenting an interactive user surface for the values of the key performance indicator for the specified time span in accordance with definitions in the composite application model (act 403). For example, presentation module 191 can present a user surface 200 to a user.

The user surface includes a key performance indicator graph indicating the value of the key performance indicator over time. For example, user surface 200 includes key performance indicator graph 201. KPI health state values 194 can provide the basis for KPI graph 201. The key performance indicator graph includes a plurality of selectable information points, each selectable information point providing relevant information for the application at particular time within the specified time span. For example, key performance indicator graph 201 includes graph point interaction 222.

The user surface also includes one or more key performance indicator health transitions indicating when the value of the key performance indicator transitioned between thresholds representing different health states for the composite application. For example, user surface 200 includes health state transitions 211. Health state transitions 211 indication when KPI health state values 194 transition between thresholds 185.

The user surface also includes interface controls configured to respond to user input to manipulate the configuration of the key performance indicator graph. The interface controls can be configured to change one or more of: the size of a sub-span within the specified time span to correspondingly change how much of the specified time span is graphically represented in the key performance indicator graph and dragging a sub-span within the specified time span to pan through specified time span. For example, user surface 200 includes preset time interaction 221 for selection a specified time range for KPI graph 201 and timer scoller 203 for panning or zooming on KPI graph 201.

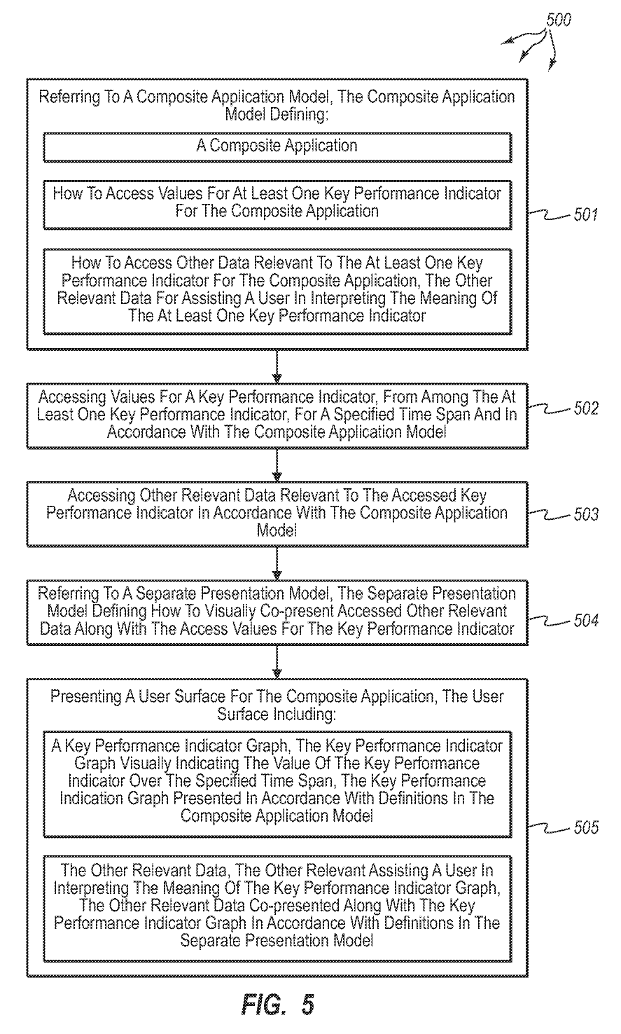

A user surface can also include other relevant data that is co-presented along with KPI health state values. FIG. 5 illustrates a flow chart of an example method 500 for correlating key performance indicator visualization with other relevant data for an application. Method 500 will be described with respect to the components and data of computer architecture 100 and with respect to user surface 200.

Method 500 includes an act of referring to a composite application model (act 501). For example, presentation module can refer to declarative model 153. The composite application model defines a composite application. For example, declarative model 153 defines distributed application 107. The composite application model also defines how to access values for at least one key performance indicator for the composite application. The composite application model also defines how to access other data relevant to the at least one key performance indicator for the composite application. The other relevant data is for assisting a user in interpreting the meaning of the at least one key performance indicator. For example, observation model 181, presentation parameters 196, or other potions of declarative model 153 can define how to collect event data for calculating key performance indicator values as well defining what other relevant data to collect.

Method 500 includes an act of accessing values for a key performance indicator, from among the at least one key performance indicator, for a specified time span and in accordance with the composite application model (act 502). For example, presentation module 191 can access KPI health state values 194 from calculation module 192 for a key performance indicator of distributed application 107.

Method 500 includes an act of accessing other relevant data relevant to the accessed key performance indicator in accordance with the composite application model (act 503). For example, presentation module 191 can access other relevant data 199 in accordance with observation model 181. Other relevant data 199 can include, for example, alerts (e.g. alerts 212), command logs (e.g., command logs 213), lifecycle data, health state transitions, events, calculable values, etc. In some embodiments, other relevant data 199 includes aggregate calculations on a collection of data. For example, other relevant data 199 can include statistical calculations (mean, min, max, medium, variance, etc.). Aggregation information can also including the total time during a time span that an event value spent above of below a threshold.

Method 500 includes an act of referring to a separate presentation model (act 504). For example, presentation module 191 can refer to co-presentation module 198. The separate presentation model defines how to visually co-present accessed other relevant data along with the access values for the key performance indicator. For example, co-presentation model 198 can define how to visually co-present other relevant data 199 along with KPI health state values 194.

Method 500 includes an act of presenting a user surface for the composite application including a key performance indication graph and the other relevant data (act 505). For example, presentation module 191 can present user surface 200 including KPI graph 201, other relevant information 204, alerts 212, and command log 213 etc., to a user.

The key performance indicator graph visually indicates the value of the key performance indicator over the specified time span. For example, KPI graph 201 indicates the value of a KPI for distributed application 207 over a specified period of time. The key performance indicator graph is presented in accordance with definitions in the composite application model. For example, KPI graph 201 can be presented in accordance with definitions in declarative application model 153. The other relevant data assists a user in interpreting the meaning of the key performance indicator graph. For example, other relevant information 204, alerts 212, command log 213, etc., assists a user in interpreting the meaning of KPI graph 201. The other relevant data is co-presented along with the KPI graph in accordance with definitions in the separate presentation model. For example, other relevant information 204, alerts 212, command log 213, etc., can be presented in accordance with definitions in co-presentation model 198.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system including an event collection infrastructure for collecting application event data from an event store, a method for calculating a key performance indicator value for an application, the method comprising:
an act of accessing a composite application model that defines a composite application, the composite application model defining where and how the composite application is to be deployed, the composite application model also including an observation model that defines how to process event data generated by the composite application, the observation model defining how to measure a key performance indicator for the composite application, including defining instructions the event collection infrastructure is to consume to determine:
what event data is to be collected from the event store for the composite application;
where to store collected event data for the composite application; and
how to calculate a health state for the key performance indicator from the stored event data;
an act of collecting event data for the composite application from the event store in accordance the defined instructions in the observation model, the event data sampled over a specified period of time;
an act of storing the collected event data in accordance with the defined instructions in the observation model; and
an act of calculating a health state for the key performance indicator across the specified period of time based on the stored event data in accordance with defined instructions in the observation model.

2. The method as recited in claim 1, wherein the act of accessing a composite application model that comprises an act of accessing a composite model that includes a key performance indicator equation, the key performance indication equation define how to calculate values for the key performance indicator.

3. The method as recited in claim 2, wherein the act of accessing a composite application model comprises an act of accessing a composite application model that includes thresholds representing transitions between key performance indicator health states.

4. The method as recited in claim 3, wherein an act of calculating a health state for the key performance indicator across the specified period comprises determine when values for the key performance transition from one side of a threshold to the other side of the threshold during the specified time period.

5. The method as recited in claim 1, further comprising:
an act of visually presenting a user surface that includes the calculated health state for the key performance indicator across the specified period of time.

6. The method as recited in claim 5, wherein the act of visually presenting a user surface comprises an act of presenting a user surface that includes interface controls for adjusting the portion of the calculated health state that is displayed at the user surface.

7. The method as recited in claim 1, wherein the act of visually presenting a user surface comprises an act of presenting a key performance indicator graph.

8. The method as recited in claim 1, wherein the act of visually presenting a user surface comprises an act of presenting a user surface that indicates transitions between health states based on defined thresholds.

9. The method as recited in claim 7, wherein the an act of presenting a user surface that indicates transitions between health states based on defined thresholds comprises an act of indication when the health state is one of ok, at risk, and critical.

10. At a computer system including a visualization mechanism for graphically presenting key performance indicator values, a method for interactively visualizing a key performance indicator value over a span of time, the method comprising:
an act of referring to a composite application model, the composite application model defining:
a composite application; and
how to graphically present an interactive user surface for the composite application from values of a key performance indicator for the composite application;
an act of accessing values of a key performance indicator for the composite application for a specified time span; and
an act of graphically presenting an interactive user surface for the values of the key performance indicator for the specified time span in accordance with definitions in the composite application model, the interactive user surface including:
a key performance indicator graph indicating the value of the key performance indicator over time, the key performance indicator graph including a plurality of selectable information points, each selectable information point providing relevant information for the application at particular time within the specified time span;
one or more key performance indicator health transitions indicating when the value of the key performance indicator transitioned between thresholds representing different health states for the composite application; and
interface controls configured to respond to user input to manipulate the configuration of the key performance indicator graph, including one or more of: changing the size of a sub-span within the specified time span to correspondingly change how much of the specified time span is graphically represented in the key performance indicator graph and dragging a sub-span within the specified time span to pan through specified time span.

11. The method as recited in claim 10, wherein the act of referring to a composite application model comprises an act of referring to a composite application model that defines how interface controls are to be configured for the interactive user surface.

12. The method as recited in claim 10, further comprising:
an act of receiving a selection of a selectable information point on the key performance indication graph; and
an act of presenting relevant information for the application at the particular time corresponding to selectable information point in response to receiving the selection.

13. The method as recited in claim 10, further comprising:
an act of receiving user input changing the size of the sub-span within the specified time span; and
an act of changing how much the specified time span is graphically presented in response to the user input.

14. The method as recited in claim 10, further comprising:
an act of receiving user input dragging a sub-span within the specified time span; and
an act of pan through specified time span in response to the user input.

15. The method as recited in claim 10, wherein the an act of graphically presenting an interactive user surface for the values of the key performance indicator for the specified time span comprises an act of presenting other data relevant to the key performance indicator graph, the other relevant data assisting a user in interpreting the meaning of the key performance indicator graph.

16. The method as recited in claim 10, wherein the act of graphically presenting an interactive user surface for the values of the key performance indicator for the specified time span comprises an act of presenting a key performance indicator graph that contains thresholds representing transitions between different health states.

17. At a computer system including a visualization mechanism for graphically presenting key performance indicator values, a method for correlating a key performance indicator visualization with other relevant data for an application, the method comprising:
an act of referring to a composite application model, the composite application model defining:
a composite application; and
how to access values for at least one key performance indicator for the composite application; and
how to access other data relevant to the at least one key performance indicator for the composite application, the other relevant data for assisting a user in interpreting the meaning of the at least one key performance indicator;
an act of accessing values for a key performance indicator, from among the at least one key performance indicator, for a specified time span and in accordance with the composite application model;
an act of accessing other relevant data relevant to the accessed key performance indicator in accordance with the composite application model;
an act of referring to a separate presentation model, the separate presentation model defining how to visually co-present accessed other relevant data along with the access values for the key performance indicator;
an act of presenting a user surface for the composite application, the user surface including:
a key performance indicator graph, the key performance indicator graph visually indicating the value of the key performance indicator over the specified time span, the key performance indication graph presented in accordance with definitions in the composite application model; and
the other relevant data, the other relevant data assisting a user in interpreting the meaning of the key performance indicator graph, the other relevant data co-presented along with the key performance indicator graph in accordance with definitions in the separate presentation model.

18. The method as recited in claim 17, wherein the key performance indicator graph includes a plurality of selectable information points corresponding to times within the specified time span, each selectable information point providing a portion of the other relevant data that was relevant for the application at the corresponding time.

19. The method as recited in claim 17, wherein the act of presenting a user surface for the composite application comprises an act of presenting statistical data assisting a user in interpreting the meaning of the key performance indicator graph.

20. The method as recited in claim 17, wherein the act of presenting a user surface for the composite application comprises an act of presenting one or more of: alerts, a command log, and lifecycle information, to assist a user in interpreting the meaning of the key performance indicator graph.
